(19) United States
(12) Patent Application Publication
(10) Pub. No.: US 2008/0163894 A1
(43) Pub. Date: Jul. 10, 2008

(54) Fluid Cleaning Apparatus

(76) Inventor: John Robert Henderson, Denver, CO (US)

Correspondence Address: Roger A. Jackson, Esq., Suite G-5, 1115 Grant Street, Denver, CO, 80203-2399, US

(21) Appl. No.: 11/620,672

(22) Filed: Jan. 7, 2007

(51) Int. Cl. B08B 7/00

(52) U.S. Cl. 134/6

(57) ABSTRACT

A fluid cleaning apparatus and method for use with a fluid interface that has structure for creating a fluid flowrate of a selected fluid, wherein the apparatus includes a housing that has a surrounding side wall about a longitudinal axis, the sidewall defining an interior between proximal end and distal end portions. The proximal end portion removably engages the fluid interface with fluid communication between the interior and the structure for creating the selected fluid's flowrate, the distal end portion including an aperture that is in fluid communication with the interior. Also included with the apparatus is an agitation element that is disposed adjacent to the distal end portion such that the aperture is in fluid communication with the agitation element and an external environment, wherein operationally the agitation element helps to dislodge a particulate from a selected surface in conjunction with the selected fluid to clean the selected surface.

### TECHNICAL FIELD

The present invention generally relates to a fluid cleaning apparatus and more particularly to a portable manually operated fluid cleaning apparatus that includes an agitation element for the cleaning of selected difficult to reach areas/surfaces such as a convoluted surface on a desired item.

### BACKGROUND OF INVENTION

There are a variety of fluid cleaning apparatus in the prior art. A fluid cleaning apparatus system typically includes: a fluid reservoir, a means for generating fluid movement, a means for regulating fluid flow, and an agitation element that is adjacent to a fluid discharge/intake nozzle. The reservoir contains a fluid and usually also has a means for motivating the fluid to communicate into the means for regulating the fluid flow and further communicating to the fluid nozzle and finally to the agitation element. The fluid can be a liquid or a gas or even a combination of a liquid and a gas wherein the reservoir and means for motivating the fluid out of or into the reservoir can be anything known in the art that can accommodate the known fluid properties such as a pump or compressor. Thus, the cleaning process can utilize the force or velocity of the fluid impinging upon the surface from the nozzle and/or the fluids solvent capabilities, conversely the cleaning process could also utilize the vacuum action of the ambient air similar to a conventional vacuum cleaner, while in any case the cleaning action receiving a helpful benefit from the agitation element to assist in breaking loose particulates that are adhering to the surface. The present invention specifically concerns the apparatus of the fluid nozzle including the means for regulating the fluid flow in combination with the agitation element. The means for regulating the fluid flow can include simply having a selectively sized fluid flow passageway, or a valve of some type. The agitation element can include a pen quill, a hollow needle being a cannula with a lumen, a brush with bristles, or a sponge type material, and the like.

There are many issues surrounding the fluid dispenser such as, how to handle the many different types of fluids and their properties, such as viscosity, miscibility of the various fluid components, and the drying or phase change characteristics of the fluid as it flows through the nozzle and onto the desired surface. Also, another issue is the communication of the fluid to the agitation element itself, such as with a conventional brush wherein the fluid is deposited all over the brush from the nozzle which typically causes and excess amount of fluid on the brush possibly lessening its ability to assist in breaking loose particulates that are adhering to the surface.

In addressing the above-identified issues that are common to fluid cleaning apparatus, the prior art discloses a number of different types of apparatus. Looking to the fluid cleaning apparatus issue of controlling or the regulating the flow of the fluid as it communicates to the nozzle, the prior art typically utilizes a valve of some type as is typically disclosed in U.S. Pat. No. 4,470,715 to Reuchlin et al., U.S. Pat. No. 6,056,470 to Nchashi et al., and U.S. Pat. No. 6,402,410 to Hall et al. Alternatively, a fluid flow restriction such as an orifice or the lumen inside of the cannula wherein the fluid dispensed must flow through the orifice or the lumen inside of the cannula is disclosed in U.S. Pat. No. 1,945,957 to Salmon, U.S. Pat. No. 1,935,639 to Keeshan, and U.S. Pat. No. 3,400,996 to Vandergrift. Obviously, for simplicity the orifice or the lumen would be the most attractive apparatus to use for controlling and regulating the flow of fluid through the nozzle, however, the disadvantage of the orifice or the lumen would be the lack of the ability to substantially stop the flow of a fluid when it is desired to prevent leakage.

The use of a valve can accommodate this requirement; however, a valve adds a degree of mechanical complexity that is generally undesirable. The prior art has recognized this problem and has attempted to solve it by making the reservoir and the means for controlling and regulating the flow of fluid as separable pieces, creating the ability to separately clean the means for controlling and regulating the flow of fluid, such as typically disclosed in U.S. Pat. No. 4,447,169 to Vartoughian. Adding the requirement that if the means for controlling and regulating the flow of fluid were removed from the reservoir requires that the reservoir outlet would have to be sealable, and have a substantially fluid tight removable engagement with the nozzle including a means for fluid communication between the reservoir and the nozzle.

In looking at the prior art for the agitation element in combination with the fluid nozzle in U.S. Pat. No. 5,839,161 to Liang disclosed is a suction pipe assembly for a vacuum cleaner, wherein the agitation element of a brush assembly is selectively positionable in relation to the fluid nozzle, however, there is no teaching of unique aspects of the fluid nozzle itself as it is a straight through fluid communication passageway. Focusing specifically upon the agitation element nozzle outlet interface, in U.S. Pat. No. 4,944,625 to Futter et al., disclosed is a powder applying brush that is concerned primarily with filtering and clogging of the nozzle from the pressure fed powder, wherein the filter is self cleaning in that it has a reverse powder flow state due to a bellows type pressure source that blows the powder into the brush and then when the bellows has a return to its original volume sucks ambient air in reverse flow across the filter to clean it. Thus Futter et al., due to the unique problems that the use of a powder would cause, attempts to overcome the loss of powder flow due to nozzle clogging. Further in this area in U.S. Pat. No. 5,572,766 to Matsuura et al., disclosed is a duct cleaning apparatus that utilizes an air nozzle in combination with a brush as specifically shown in FIG. 5, having a segmented rotating brush with air nozzles between the brush segments, however, there is nothing unique about the brush/nozzle interface as Matsuura et al., is a combination of the remote control duct interior moving carriage and the rotating brush/nozzle assembly.

What is needed, is a simple and inexpensive convoluted surface fluid cleaning apparatus that can effectively be manually controlled to selectively clean typical “hard to get at” surfaces that have semi inaccessible concavities and the like, wherein the fluid cleaning apparatus utilizes a fluid aperture adjacent to the agitation element to help accomplish the desired cleaning. The fluid aperture can flow either direction in that it can blow forward or outward into the agitation element to disperse the particulate away from the surface after the agitation element has helped break the adhesion of the particulate on the surface. In addition, the fluid itself can be a gas or a liquid with optional solvent type capabilities that can assist in reducing the adhesion of the particulate on the surface, or a combination of a gas and liquid. Further, the fluid aperture can flow in a reverse direction similar to a vacuum cleaner to help remove the particulate that has been dislodged or partially dislodged from the surface by the agitation element, wherein the vacuum can help to also dislodge the particulate from the surface. Continuing the aperture can also have the means of controlling or regulating the fluid flow in addition to directional and dispersing control of the fluid in relation to the agitation element. The agitation element itself can be in the form of a brush, pick (cannula), a sponge type material, and the like. Yet, further the agitation element could have adjustable bristles to substantially conform to the convoluted surface to be cleaned to increase the effectiveness of dislodging the particulate from the surface. In addition, the fluid cleaning apparatus can have various handle configuration options that can add to the ergometric versatility of the apparatus.

### SUMMARY OF INVENTION

The present invention is a fluid cleaning apparatus that adapted for use with a fluid interface that is in fluid communication with structure for creating a fluid flowrate of a selected fluid, wherein the present invention includes a housing that has a surrounding sidewall positioned about a housing longitudinal axis, the sidewall defining a housing interior in between a proximal end portion and a distal end portion. The proximal end portion is adapted to removably engage the fluid interface with fluid communication between the housing interior and the structure for creating the selected fluid's flowrate, the distal end portion including an aperture that is in fluid communication with the housing interior. Also included with the fluid cleaning apparatus is an agitation element that is disposed adjacent to the distal end portion such that the aperture is in fluid communication with the agitation element and an external environment, wherein operationally the agitation element helps to dislodge a particulate from a selected surface in conjunction with the selected fluid to clean the selected surface.

These and other objects of the present invention will become readily appreciated and understood from a consideration of the following detailed description of the exemplary embodiments of the present invention when taken together with the accompanying drawings, in which;

### BRIEF DESCRIPTION OF DRAWINGS

FIG. 1 is a perspective view of the fluid cleaning apparatus;

FIG. 2 is a perspective cross sectional view of the fluid cleaning apparatus;

FIG. 3 is a perspective view of the fluid cleaning apparatus with a plurality of brush bristles having free tip portions that form a brush opening that includes two oppositely disposed concave sections and two oppositely disposed convex sections that form a continuously curved perimeter;

FIG. 4 is an exploded perspective view of an alternative embodiment of the fluid cleaning apparatus;

FIG. 5 is an exploded perspective cross sectional view of an alternative embodiment of the fluid cleaning apparatus;

FIG. 6 is an exploded perspective cross sectional view of the distal end portion, aperture, and agitation element in the form of the plurality of brush bristles with the selected fluid shown;

FIG. 7 is an exploded perspective cross sectional view of the distal end portion and aperture with the cannula and lumen in the form of a pick, including the selected fluid shown;

FIG. 8 is an exploded perspective cross sectional view of the distal end portion, aperture, and agitation element in the form of an open cell foam element, with the selected fluid shown;

FIG. 9 is an exploded perspective cross sectional view of the distal end portion, aperture that includes the flow diffuser, and agitation element in the form of the plurality of brush bristles with the selected fluid shown;

FIG. 10 is an exploded perspective cross sectional view of the distal end portion, aperture, and agitation element in the form of the plurality of brush bristles, wherein each of a plurality of bristles are sized and configured to be each selectively positioned substantially along the longitudinal axis with the selected fluid shown;

FIG. 11 is an exploded perspective view of the fluid cleaning apparatus with a fluid interface in the form of an air valve adjacent to an air supply hose from the means for creating a fluid flowrate of the selected fluid;

FIG. 12 is a perspective view of the fluid cleaning apparatus with a fluid interface int eh form of an air valve adjacent to an air supply hose from the means for creating a fluid flowrate of the selected fluid;

FIG. 13 is a perspective view of the fluid cleaning apparatus in use with a fluid interface in the form of an air valve adjacent to an air supply hose from the means for creating a fluid flowrate of the selected fluid, wherein the fluid cleaning apparatus is used to clean the selected surface of a keyboard;

FIG. 14 is a perspective view of the alternative embodiment of the fluid cleaning apparatus in use with a fluid interface that is adjacent to an air supply hose, with the fluid cleaning apparatus including means for controlling the selected fluid's flowrate, wherein the fluid cleaning apparatus is used to clean the selected surface of a keyboard; and

FIG. 15 is a perspective view of the alternative embodiment of the fluid cleaning apparatus in use with a fluid interface that is adjacent to an air supply hose, with the fluid cleaning apparatus including a means for controlling the selected fluid's flowrate, wherein the fluid cleaning apparatus is used to clean the selected surface of a keyboard, the brush bristles are selectively positioned substantially along the longitudinal axis to operationally further accommodate an approximate match in selected brush opening profile to a profile of the selected surface to be cleaned.

### REFERENCE NUMBERS IN DRAWINGS

30 Fluid cleaning apparatus

### 32 Housing

34 Housing longitudinal axis
36 Surrounding sidewall
38 Housing interior
40 Proximal end portion
42 Distal end portion

### 44 Aperture

46 Aperture flow restriction

### 48 Pick

### 50 Cannula

### 52 Lumen

54 Lumen flow restriction
56 Means for controlling the selected fluid's flowrate from the aperture 44
58 Tapered seat type valve
59 External valve
60 Agitation element
61 Agitation element outer retainer
62 Open celled foam element
63 Agitation element inner retainer

### 64 Brush

66 Plurality of bristles
68 Free tip portions of plurality of brush bristles 66
70 Brush 64 opening
72 Continuously curved perimeter profile
74 Oppositely disposed concave sections
76 Oppositely disposed convex sections
78 Diffusing flow restriction
80 Sizing and configuring of each of brush plurality of bristles 66 to be selectively positioned along the housing 32 or 132 longitudinal axis 34
82 Selected brush 64 opening profile
84 Fluid interface

### 85 Hose

86 Means for creating a fluid flowrate
88 Selected fluid
90 Removable engagement of the fluid interface 84 or 184
92 Fluid communication at the fluid interface 84 or 184
94 Fluid communication between housing interior 38 or 138 and the means 86 for creating a fluid flowrate
96 Fluid communication between aperture 44 or 144 and the housing interior 38 or 138
98 Fluid communication between the aperture 44 or 144 and the agitation element 60
99 Fluid communication between the agitation element 60 and the external environment 102
100 Fluid communication between the aperture 44 or 144 and the lumen 52
102 External environment

### 104 Particle

106 Dislodging a particle
108 Selected surface
110 Profile of selected surface
112 Human hand
114 Manually grasped
116 Flowrate of the selected fluid 88
118 Dispersion of the selected fluid 88
120 Attaching the proximal end portion 40 or 140 to the fluid interface 84
122 Positioning manually the plurality of brush bristles 66 to form a selected brush opening profile 82
124 Adjusting the means 56 for controlling the selected fluid's 88 flowrate
126 Moving the selected brush opening profile 82 back and forth across the selected surface profile 110
130 Alternative embodiment of the fluid cleaning apparatus
132 Alternative embodiment of the housing
134 Alternative embodiment longitudinal axis
136 Alternative embodiment of surrounding sidewall
138 Alternative embodiment of housing interior
140 Alternative embodiment of the proximal end portion
142 Alternative embodiment of the distal end portion
144 Alternative embodiment of the aperture
146 Alternative embodiment of the aperture 144 flow restriction
184 Alternative embodiment of the fluid interface

190 Alternative embodiment of the removable engagement of the fluid interface 184

### DETAILED DESCRIPTION

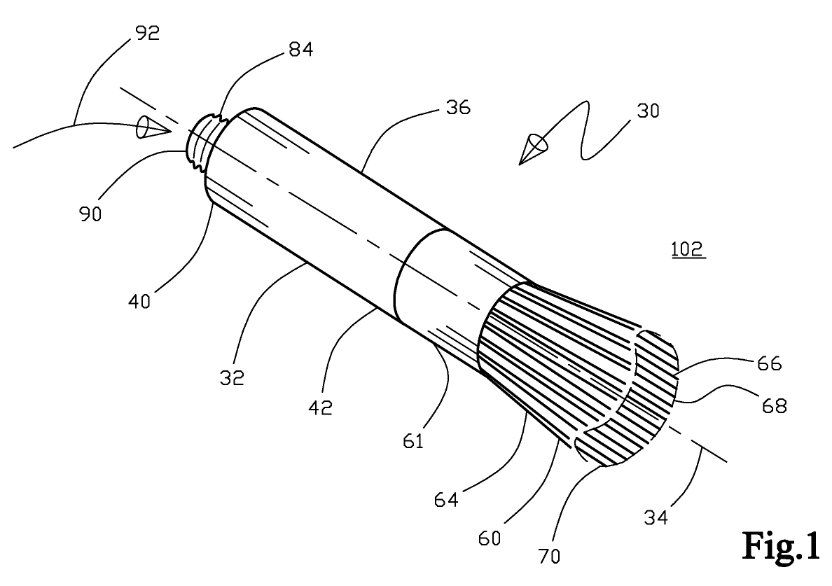

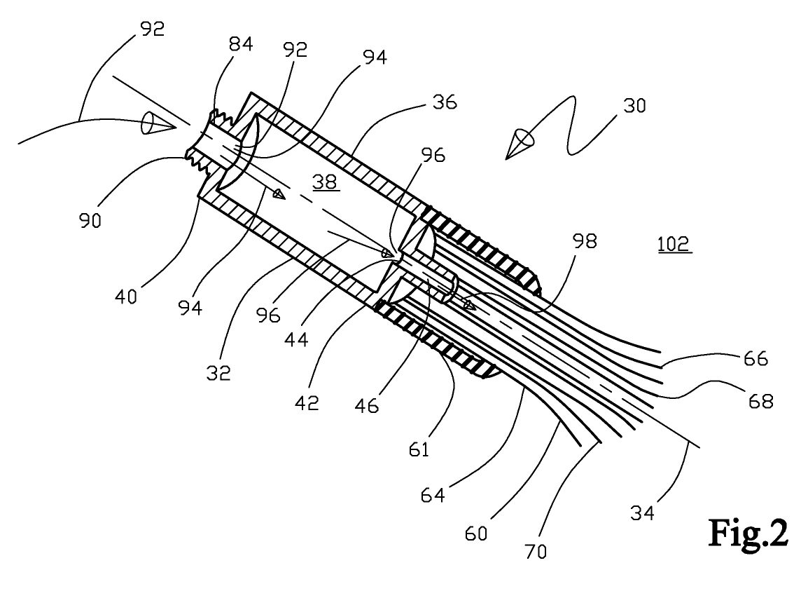

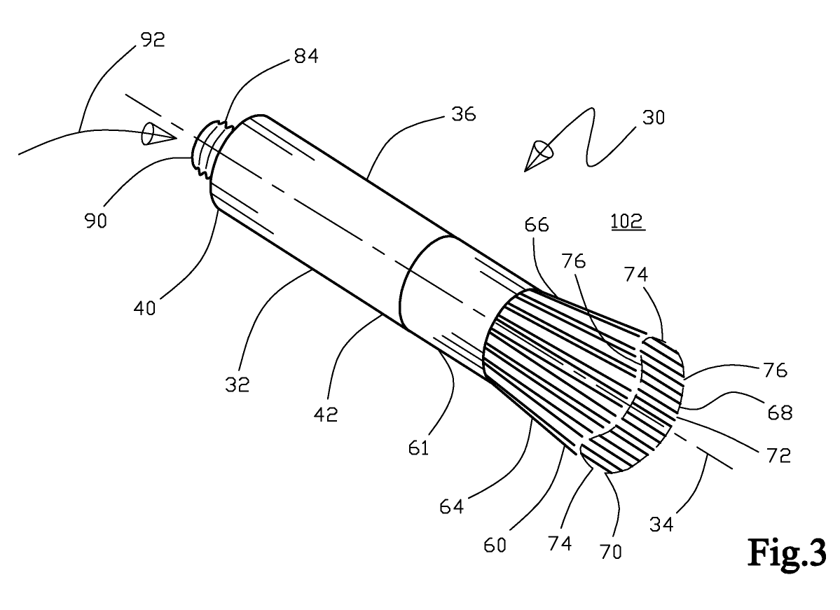

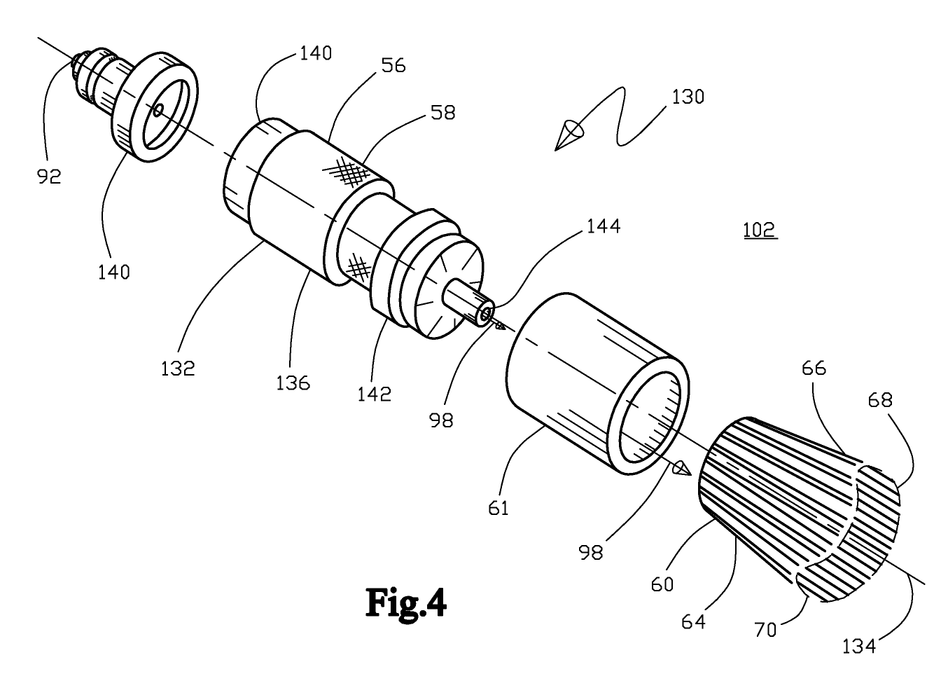

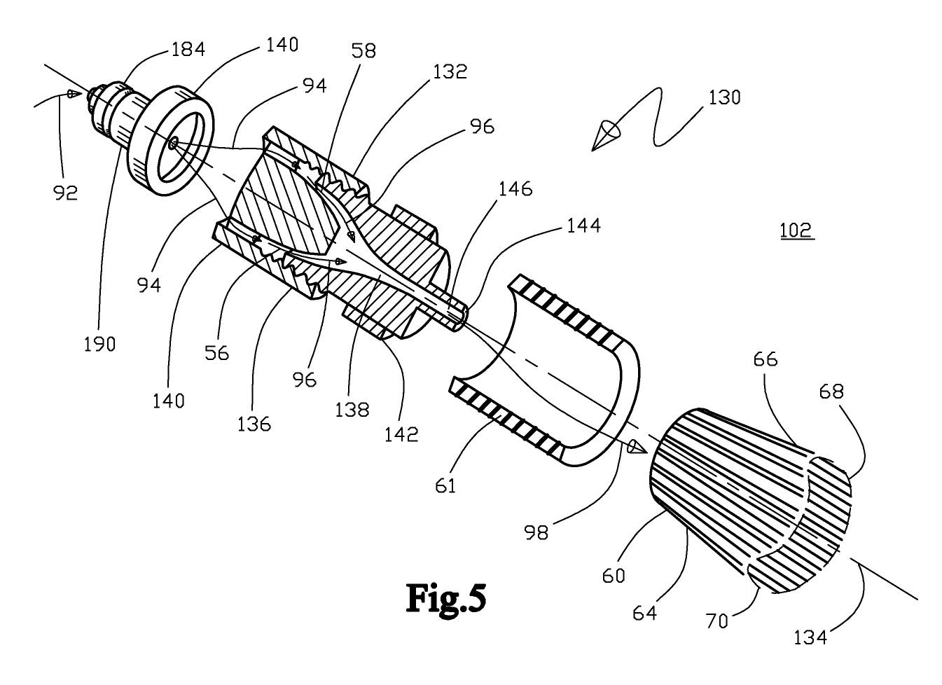

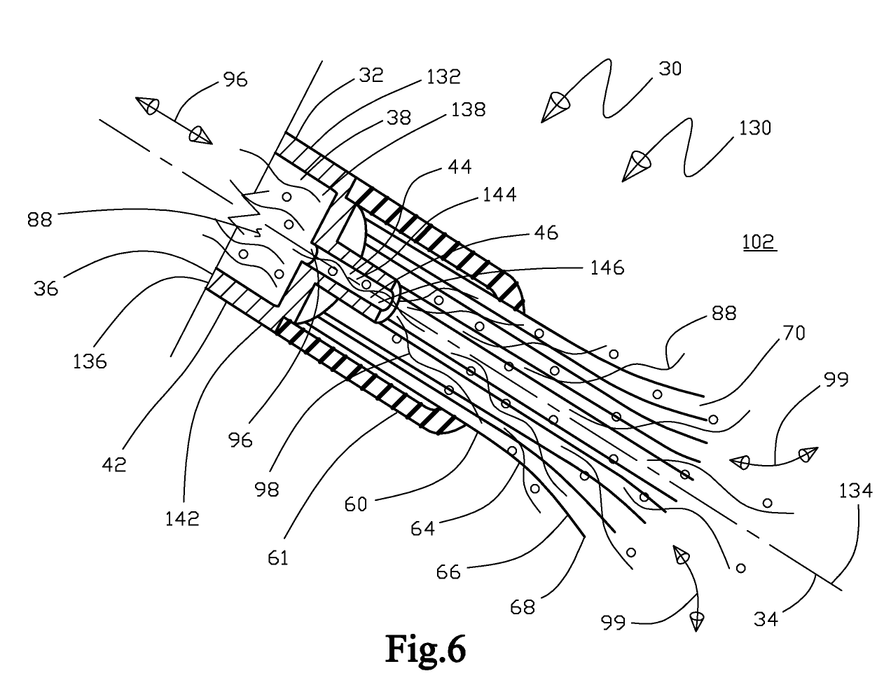

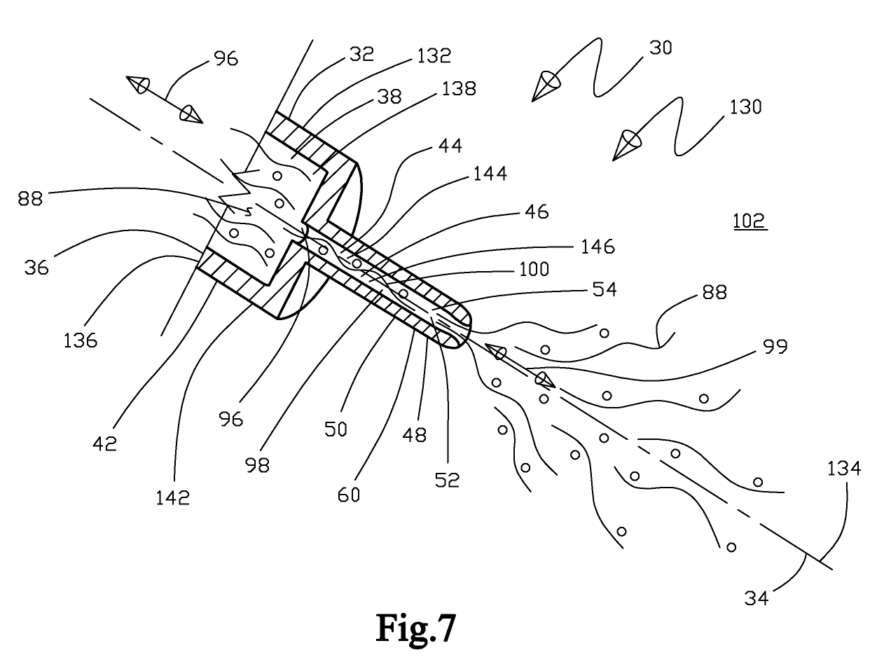

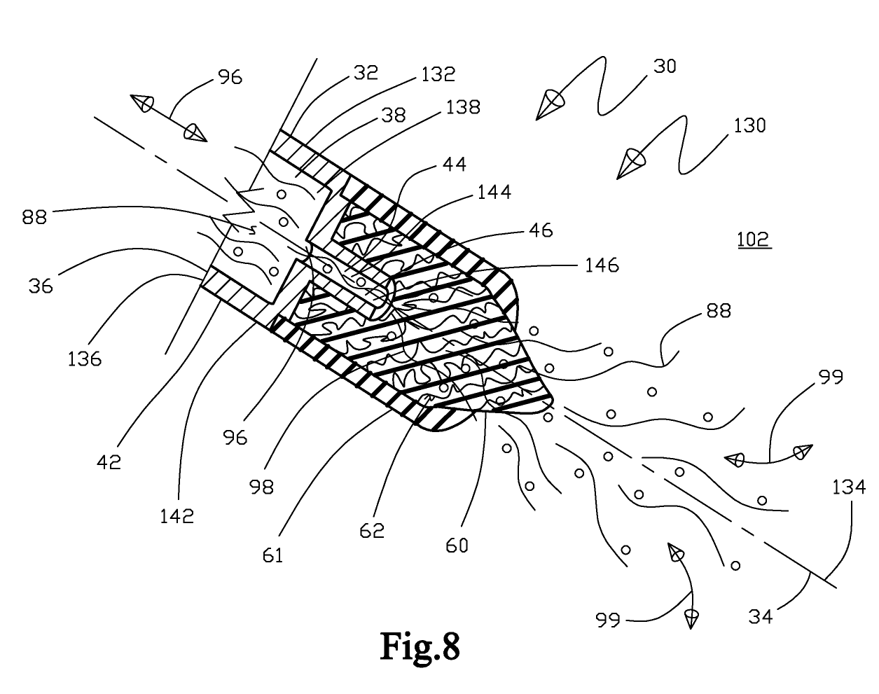

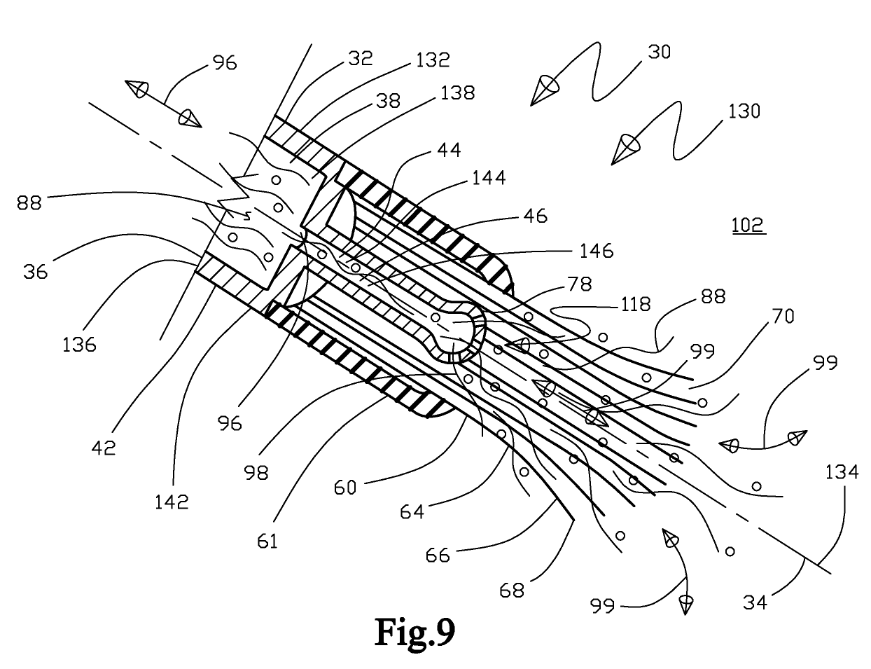

With initial reference to FIG. 1 shown is a perspective view of the fluid cleaning apparatus 30, FIG. 2 is a perspective cross sectional view of the fluid cleaning apparatus 30, and FIG. 3 is a perspective view of the fluid cleaning apparatus 30 with a plurality of brush 64 bristles 66 having free tip portions 68 that form a brush opening 70 that includes two oppositely disposed concave sections 74 and two oppositely disposed convex sections 76 that form a continuously curved perimeter 72. Continuing, FIG 4 is an exploded perspective view of an alternative embodiment of the fluid cleaning apparatus 130, FIG. 5 is an exploded perspective cross sectional view of an alternative embodiment of the fluid cleaning apparatus 130, and FIG. 6 is an exploded perspective cross sectional view of the distal end portion 42 or 142, the aperture 44 or 144, and the agitation element 60 in the form of the plurality of brush 64 bristles 66 with the selected fluid shown 88. Further continuing, FIG. 7 is an exploded perspective cross sectional view of the distal end portion 42 or 142 and aperture 44 or 144 with the cannula 50 and lumen 52 in the form of a pick 48, including the selected fluid 88 shown. FIG. 8 is an exploded perspective cross sectional view of the distal end portion 42 or 142, the aperture 44 or 144, and agitation element 60 in the form of an open cell foam element 62, with the selected fluid shown 88. FIG. 9 is an exploded perspective cross sectional view of the distal end portion 42 or 142, the aperture 44 or 144 that includes the flow diffuser 78, and the agitation element 60 in the form of the plurality of brush 64 bristles 66 with the selected fluid shown 88.

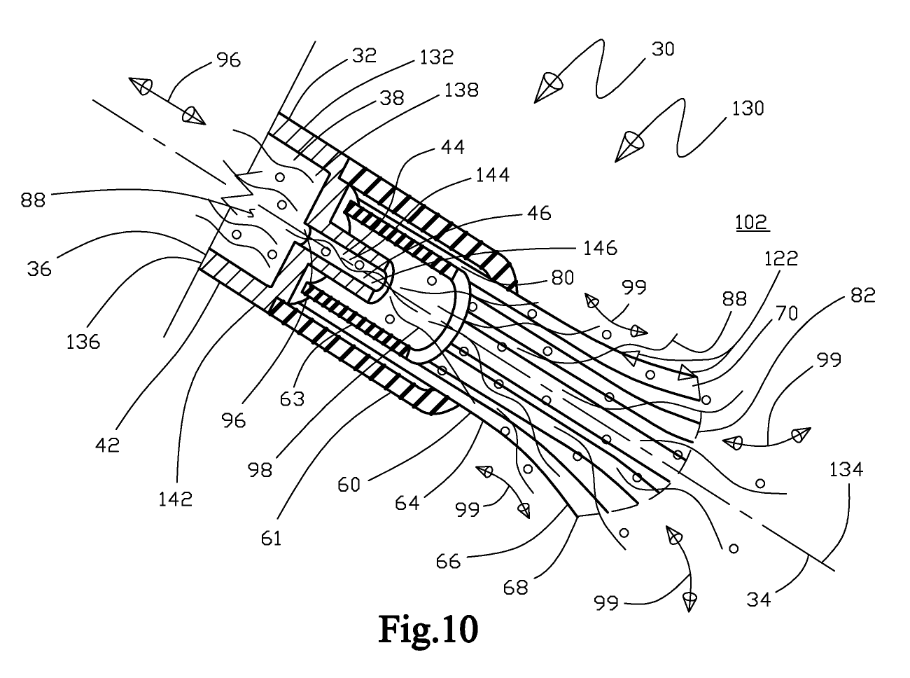

Next, FIG. 10 is an exploded perspective cross sectional view of the distal end portion 42 or 142, the aperture 44 or 144 that includes the flow diffuser 78, and the agitation element 60 in the form of the plurality of brush 64 bristles 66 with the selected fluid shown 88.

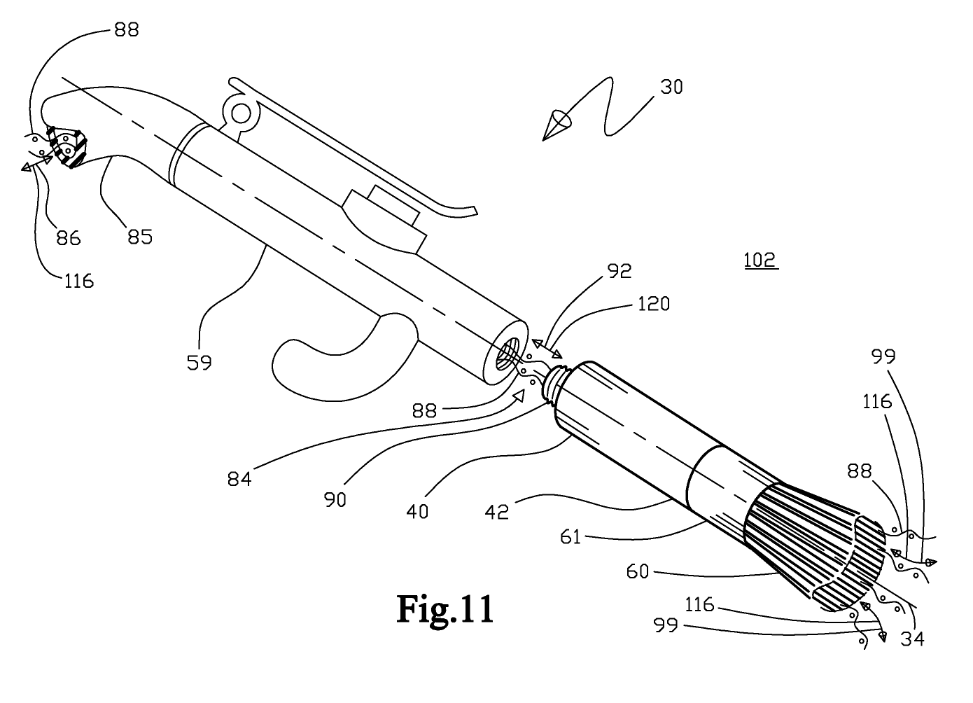

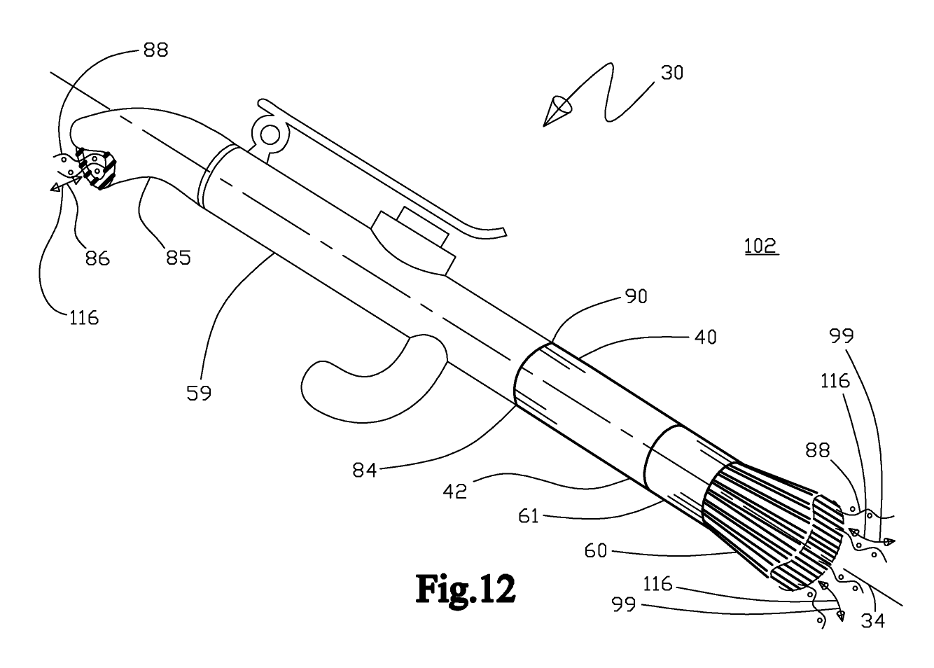

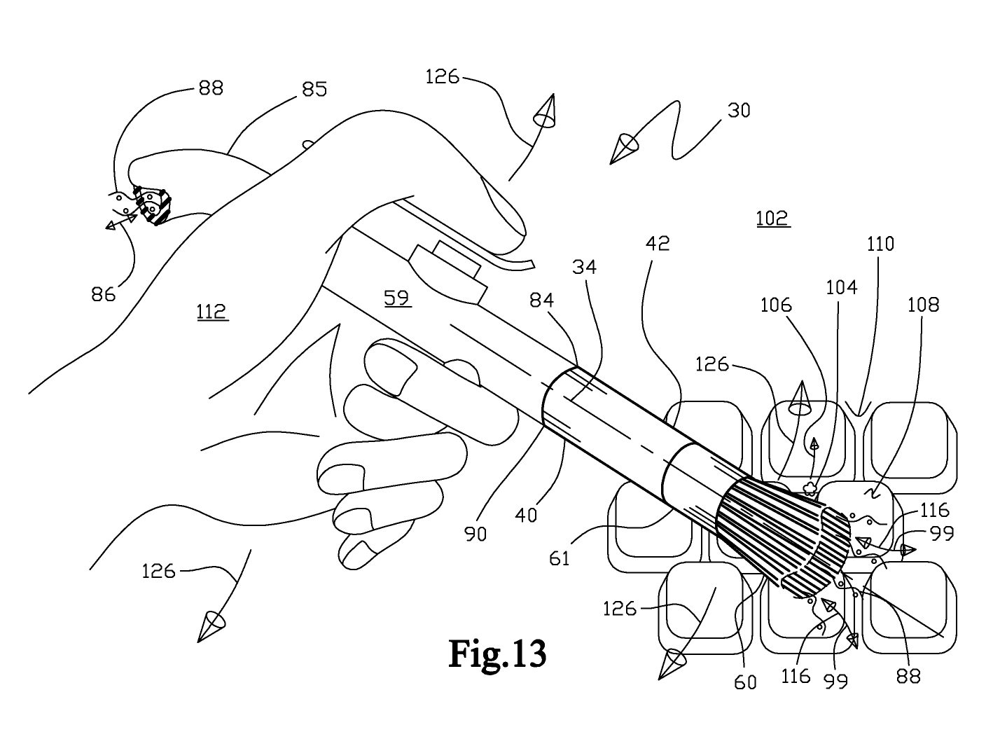

Next, FIG. 10 is an exploded perspective cross sectional view of the distal end portion 42 or 142, the aperture 44 or 144, and agitation element 60 in the form of the plurality of brush 64 bristles 66, wherein each of a plurality of bristles 66 are sized and configured 80 to be each selectively positioned substantially along the longitudinal axis 34 or 134 with the selected fluid shown 88. yet further, FIG. 11 is an exploded perspective view of the fluid cleaning apparatus 30 with a fluid interface 84 in the form of an air valve 59 adjacent to an air supply hose 85 from the means 86 for creating a fluid flowrate 116 of the selected fluid 88. Further, FIG. 12 is an assembled perspective view of the fluid cleaning apparatus 30 with a fluid interface 84 in the form of an air valve 59 adjacent to an air supply hose 85 from the means 86 for creating a fluid flowrate 116 of the selected fluid 88. Next, FIG. 13 is a perspective view of the fluid cleaning apparatus 30 in use with a fluid interface 84 in the form of an air valve 59 adjacent to an air supply hose 85 from the means 86 for creating a fluid flowrate 116 of the selected fluid 88, where in the fluid cleaning apparatus 30 is used to clean the selected surface 108 of a keyboard as an example.

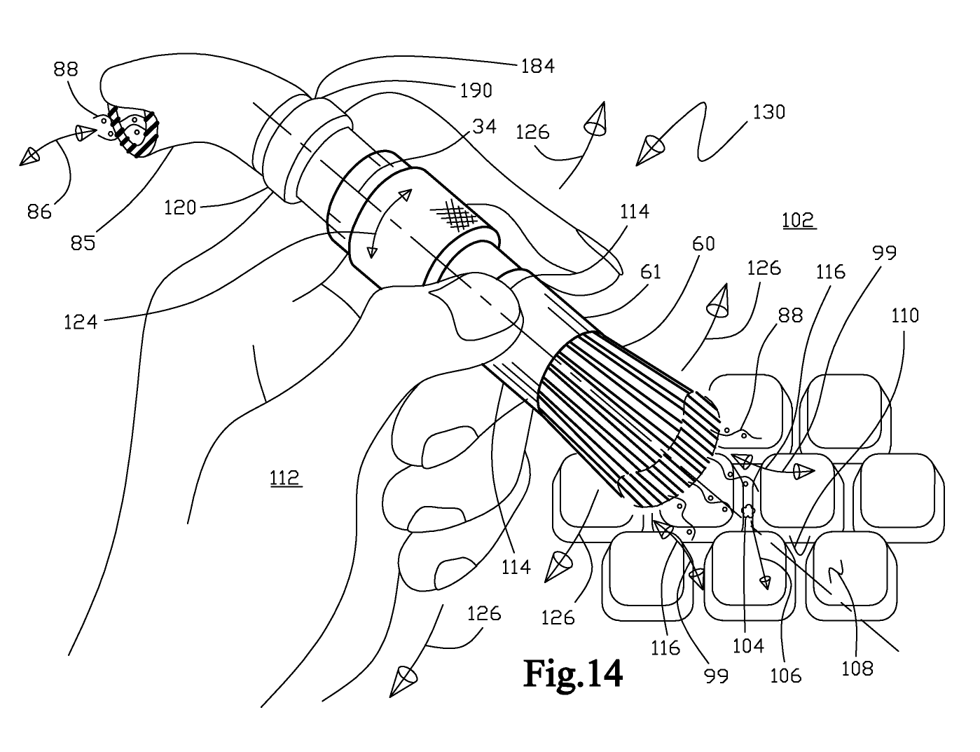

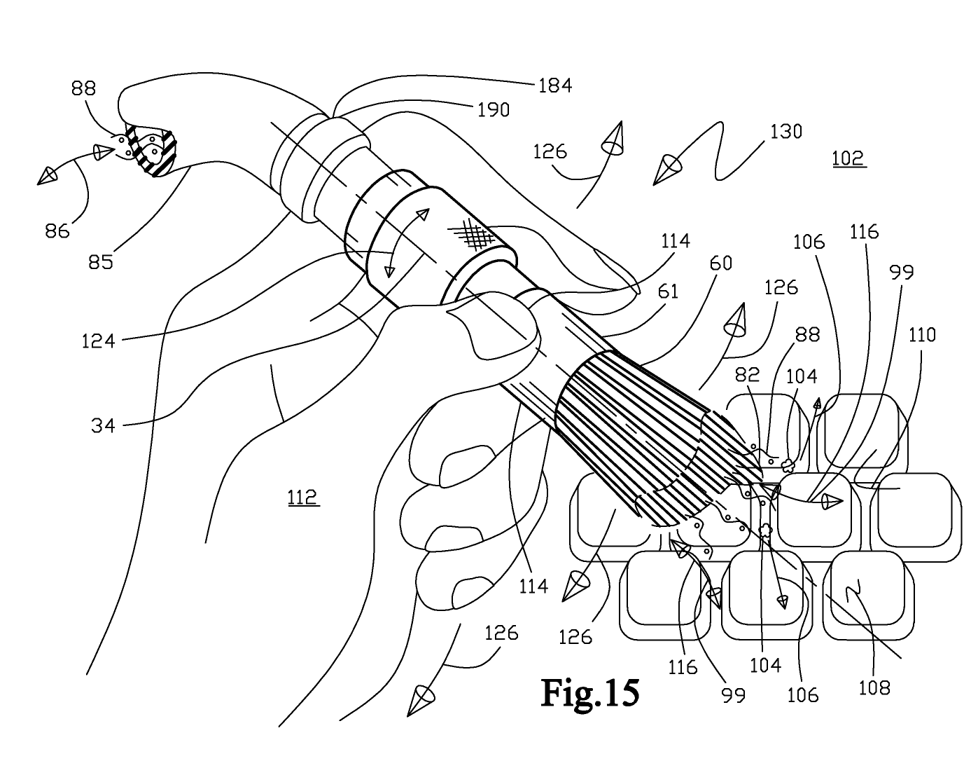

Moving onward, FIG. 14 is a perspective view of the alternative embodiment of the fluid cleaning apparatus 130 in use with a fluid interface 184 that is adjacent to an air supply hose 85, with the fluid cleaning apparatus 130 including a means 56 for controlling the selected fluid's 88 flowrate 116, wherein the fluid cleaning apparatus 130 is used to clean the selected surface 108 of a keyboard as an example. Furthermore, FIG. 15 is a perspective view of the alternative embodiment of the fluid cleaning apparatus 130 in use with a fluid interface 184 that is adjacent to an air supply hose 85, with the fluid cleaning apparatus 130 including a means 56 for controlling the selected fluid's 88 flowrate 116, wherein the fluid cleaning apparatus 130 is used to clean the selected surface 108 of a keyboard as an example. In FIG. 15, the brush 64 bristles 66 are selectively positioned 80 substantially along the longitudinal axis 134 to operationally further accommodate an approximate match in selected brush 64 opening 70 profile 82 to a profile 110 of the selected surface 108 to be cleaned.

Broadly, refer to FIGS. 1 to 3 for basic structure of the fluid cleaning apparatus 30, FIGS. 11 to 13 for the use of the fluid cleaning apparatus 30, and FIGS. 6 to 10 for alternatives related to the aperture 44 and the agitation element 60 of the fluid cleaning apparatus 30. Moving to specifics, the present invention of a fluid cleaning apparatus 30 is adapted for use with a fluid interface 84 that is in fluid communication 92 with a means 86 for creating a selected fluid flowrate 116 of a selected fluid 88 as best shown in FIGS. 11 through 13. Preferably the fluid interface 84 is a conventional removably engagable air hose type fitting that can be threaded or a spring loaded snap ball arrangement, or the like as is known in the art. As is shown in FIGS. 11 to 13, an optional air valve 59 as is known in the art can be utilized for convenience to have on/off control for the flow 116 of the selected fluid 88, noting that the selected fluid 88 is preferably air, however, other fluids could be used that are multi phase mixtures of a liquid and a gas, or a liquid, wherein the liquid could have desirable solvent type properties to enhance the cleaning process, such as alcohol, degreasers, and the like.

As to the means 86 for creating a selected fluid 88 flowrate 116 preferably this is an air compressor that is typically used in a shop or factory in an industrial application that delivers air at about 100 psig pressure at about 30 ACFM volumetric flowrate at the delivery pressure of 100 psig. However, air compressors for medical use or sanitary use for human consumption of the air, i.e. scuba diving could also be used, in addition to compressors utilized for other gases as is known in the art. Further, if the selected fluid 88 is a liquid, a pump would be utilized also being sized and configured for the desired pressures and flowrates 116 also as is well known in the art for the pump selection as is required for the fluid cleaning apparatus 30. Continuing, if the selected fluid 88 is a liquid/gas mixture with known properties, such as mass density, viscosity, vapor pressure, and the like, along with a desired pressure and flowrate 116, then also a pump or compressor can be selected per commonly known engineering criterion.

Continuing, in specifically referring to FIGS. 1 through 3, the fluid cleaning apparatus 30 further includes a housing 32 that has a surrounding side wall 36 positioned about a housing longitudinal axis 34, the sidewall 36 defining a housing interior 38 that is in between a proximal end portion 40 and a distal end portion 42, as best shown in FIG. 2. The proximal end portion 40 is adapted to removably engage 90 the fluid interface 84 with fluid communication 94 between the housing interior 38 and the means 86 for creating the selected fluid's 88 flowrate 116 also as best shown in FIG. 2. The distal end portion 42 also includes an aperture 44 that is in fluid communication 96 with the housing interior 38, again as best shown in FIG. 2. Yet further, the fluid cleaning apparatus 30 includes an agitation element 60 that is disposed adjacent to the distal end portion 42 such that the aperture 44 is in fluid communication 98 with the agitation element 60 and an external environment 102, also as is best shown in FIG. 2. Wherein, operationally the agitation element 60 helps to dislodge 106 a particulate 104 from a selected surface 108 in conjunction with the selected fluid 88 to clean the selected surface 108 as best shown in FIG. 13.

Thus, in continuing to focus primarily upon FIG. 13, the fluid cleaning apparatus 30 cleans the selected surface 108 two ways that are either effective together or effective separately, by firstly physically dislodging 106 the particle 104 from the agitation element 60 by manual movement 126 of the human hand 112 at the agitation element 60 as against the selected surface 108. Then secondly by use of the selected fluid 88, that can also have two ways of helping to dislodge 106 the particle 108, a primary way by also physically dislodging 106 the particle 108 either by the selected fluid 88 flowing 116 outward away from the agitation element 60 into the external environment 102, thus “blowing” the particle 104 away from the selected surface 108 or by vacuum action, thus reversing the flow 116 to go from the external environment 102 into the agitation element and into the aperture 44, thus permanently removing the particle 104 from the selected surface 108. In addition, the selected fluid 88 can have solvent type properties that can reduce the adhesion of the particle 104 to the selected surface 108, by helping to reduce surface tension of the particle 104 to the selected using the agitation element 60 and the selected fluid 88 to either physically remove the particle 104 and/or help to loosen the particle's 104 adhesion to the selected surface 108 for convoluted type surfaces 108 that are difficult to clean in a conventional manner.

The fluid cleaning apparatus 30 optionally has the housing 32 being sized and configured to be manually grasped 114 by a human hand 112 much like as shown in FIGS. 14 and 15 which are for the alternative embodiment of the fluid cleaning apparatus 130, however the fluid cleaning apparatus 30 as is shown in FIG. 13 where the human had 112 is shown grasping the air valve 59, however, as the air valve 59 is optional the human hand 112 could grasp the housing 32, or even if the air valve 59 is used as additional human hand 112 could grasp the housing 32. Focusing more particularly on the surrounding sidewall 36 of the housing 32 and looking at specifically FIGS. 1 through 3, the sizing and configuring of the surrounding side wall portion 36 of the housing 32 to be manually grasped 114 by a human hand 112 requires that the sidewall 36 diameter or other dimension that is positioned transverse to the longitudinal axis 34 be in the range of about 0.25 (one quarter inch) to 2.00 (two) inches. Note that the sidewall 36 need not necessarily be round or circular at all, as it could be square, rectangular, elliptical, or any other shape that is transverse to the longitudinal axis 34. Also, there can optionally be ergometric type depressions in the sidewall 36 for fingers of the human hand 112 to reside in. In addition, the sidewall 36 surface that comes into contact with the human hand 112 can have a knurled type surface, or any other type of surface that increases the coefficient of friction between the human hand 112 and the sidewall 36 surface for more effective grasping 114 by the human hand 112.

On the fluid cleaning apparatus 30, the agitation element 60 can take on a number of alternative forms, referring specifically to FIG. 7; the agitation element 60 can take on a number of alternative forms, referring specifically to FIG. 7; the agitation element 60 is alternatively a pick 48 including a cannula 50 with a lumen 52, wherein the aperture 44 is in fluid communication 100 with the lumen 52. Further, optionally the lumen 52 is sized with a flow restriction to control a flowrate 116 of the selected fluid 88. The lumen 52 flow restriction can be sized per standard orifice engineering calculations that set the cross sectional area, being transverse to the longitudinal axis 34 or 134 based upon the desired selected fluid 88 flowrate 116 coinciding with a desired pressure drop across the lumen 52 using the fluid properties of the selected fluid 88 such as density, viscosity, and the like. Further, in referring specifically to FIG. 8, the agitation element 60 can alternatively be an open celled foam element 62 that can have a variety of tip options opposite of the aperture 44 for cleaning the selected surface 108, as is shown in FIG. 8 the open celled foam element has a blunt nosed tip that could also be any other shape such as frustroconical, cylindrical, square, have a hollow tip, and the like. The selected fluid 88 will permeate through the open celled foam element 62 to enhance the cleaning process by allowing the selected fluid 88 to contact the selected surface 108 in an oozing manner, allowing a “soft” contact of the selected fluid 88 with the selected surface 108.

In addition, focusing specifically on FIGS. 6 through 10, optionally the aperture 44 can be sized with a flow restriction to control a flowrate 116 of the selected fluid 88, as with the previously described lumen 52, the aperture 44 flow restriction can be sized per standard orifice engineering calculations that set the cross sectional area, being transverse to the longitudinal axis based upon the desired selected fluid 88 flowrate 116 coinciding with a desired pressure drop across the aperture 44 using the fluid properties of the selected fluid 88 such as density, viscosity, and the like. As a further option, in looking at FIG. 9, the aperture 44 can be sized with a diffusing flow restriction 78, similar to a “showerhead” to control a flowrate and dispersion of the selected fluid 88. The diffusing flow restriction 78 can be sized and configured as a restriction orifice similar to the lumen 52 and aperture 44 previously described by utilizing a plurality of orifices flowing in a parallel manner per generally known engineering multiple orifice sizing calculations and based upon the desired selected fluid 88 flowrate 116 coinciding with a desired pressure drop across the diffusing flow restriction 78 using the fluid properties of the selected fluid 88 such as density, viscosity, and the like. Operationally, the diffusing flow restriction 78 acts to have the selected fluid 88 permeate out through the plurality of brush 64 bristles 66 more thoroughly to help the cleaning process of the selected surface 108.

Continuing on the alternatives for the agitation element 60, in looking at FIGS. 1 through 3, FIG. 6, and FIGS. 9 through 13, preferably the agitation element 60 is a brush 64 having a plurality of bristles 66. The bristles 66 are retained by an agitation element retainer 61, wherein the retainer 61 is attached to the distal end portion 42 through a shoulder arrangement that can be slip fit, press fit, shrink fit, or alternatively attached by threads, a snap type fit, adhesive, or any other suitable method. On the bristles 66 themselves being attached to the retainer 61 by an adhesive, crimping, banding, or other method either or both at the bristle 66 proximal ends and/or outer radial portions, a void can exist within the bristles 66 adjacent to the aperture 44 area. To better increase the effectiveness of the bristles in looking at the free tip portions or the distal ends of the plurality of brush bristles 68 that form the brush opening 70, modification of the brush opening profile 70 can be done to approximately match the selected surface 108 profile 110, wherein the free tip portions of the bristles 68 can more effectively physically dislodge 106 the particle 104 from the selected surface 108 that is typically convoluted or corrugated in profile, being difficult to clean conventionally.

One particular profile in referring to FIG. 3, is for the plurality of bristles free tip portions 68 to form a brush opening profile 70 that has a continuously curved perimeter 72 profile that defines a brush opening profile 70 that includes oppositely disposed concave sections 74 and oppositely disposed convex sections 76. Wherein the concave 74 and convex 76 sections are continuous forming the continuously curved perimeter profile 72, with the concave 74 or convex 76 surfaces being approximately matched in brush opening 70 profile 72 to the selected surface 108 profile 110 to be cleaned. Taking this even a step further, in referring specifically to FIG. 10, by making the brush 64 bristles 68 manually selectively adjustable in creating a custom brush 64 opening 70 profile, almost any selected surface 108 profile 110 can be accommodated for effective cleaning. Thus, each of the brush 64 plurality of bristles 66 are sized and configured to be each selectively positioned 122 substantially along the longitudinal axis 34 to operationally further accommodate an approximate match in profile formed at a selected brush 64 opening profile 70 to a profile 110 of the surface 108 to be cleaned. This sizing and configuring, as shown in FIG. 10, is preferably accomplished by the addition of an agitation element inner retainer 63 that radially “sandwiches” the plurality of bristles 66 between the agitation element outer retainer 61. Thus, resulting in a frictional slidable engagement of the plurality of bristles 66 in between the outer retainer 61 and the inner retainer 63 substantially along the longitudinal axis 34, wherein the inner retainer 63 may or may not be attached to the distal end portion 42.

Broadly, refer to FIGS. 4 and 5 for basic structure of the alternative embodiment of the fluid cleaning apparatus 130, FIGS. 14 to 15 for the use of the alternatives related to the aperture 144 and the agitation element 60 of the alternative embodiment of the fluid cleaning apparatus 130. Moving to specifics, the present invention of the fluid cleaning apparatus 130 is adapted for use with a fluid interface 184 that is in fluid communication 92 with a means 86 for creating a selected fluid flowrate 116 of a selected fluid 88 as best shown in FIGS. 14 and 15. Preferably the fluid interface 184 is a conventional removably engagable air hose type fitting that can be threaded or a spring loaded snap ball arrangement, or the like as is known in the art. Noting that the selected fluid 88 is preferably air, however, other fluids could be used that are multi phase mixtures of a liquid and a gas, or a liquid, wherein the liquid could have desirable solvent type properties to enhance the cleaning process, such as alcohol, degreasers, and the like.

As to the means 86 for creating a selected fluid 88 flowrate 116 preferably this is an air compressor that is typically used in a shop or factory in an industrial application that delivers air at about 100 psig pressure at about 30 ACFM volumetric flowrate at the delivery pressure of 100 psig. However, air compressors for medical use or sanitary use for human consumption of the air, i.e. scuba diving could also be used, in addition to compressors utilized for other gases as is known in the art. Further, if the selected fluid 88 is a liquid, a pump would be utilized also being sized and configured for the desired pressures and flowrates 116 also as is well known in the art for the pump selection as is required for the fluid cleaning apparatus 130. Continuing, if the selected fluid 88 is a liquid/gas mixture with known properties, such as mass density, viscosity, vapor pressure, and the like, along with a desired pressure and flowrate 116, then also a pump or compressor can be selected per commonly known engineering criterion.

Continuing, in specifically referring to FIGS. 4 and 5, the fluid cleaning apparatus 130 further includes a housing 132 that has a surrounding sidewall 136 positioned about a housing longitudinal axis 134, the sidewall 36 defining a housing interior 138 that is in between a proximal end portion 140 and a distal end portion 142, as best shown in FIG. 5. The proximal end portion 140 is adapted to removably engage 190 the fluid interface 184 with fluid communication 94 between the housing interior 138 and the means 86 for creating the selected fluid's 88 flowrate 116 also as best shown in FIGS. 14 and 15. Note that the proximal end portion 140 in FIG. 5 is shown separated from the housing 132 for pictorial clarity, however, the proximal end portion 140 can be either integral or removably attachable to the housing 132 as long as fluid communication 94 is maintained. The distal end portion 142 also includes an aperture 144 that is in fluid communication 96 with the housing interior 138, as best shown in FIG. 5. Also included in the fluid cleaning apparatus 130 is a means 56 for controlling the selected fluid's flowrate 116 from the aperture 144 as shown in FIG. 5. Preferably, the means 56 for controlling the selected fluid's flowrate 116 from the aperture 144 is a tape red seat valve 58, similar to a needle valve also as best shown in FIG. 5, the tapered seat valve 58 is disposed in between the housing 132 proximal end portion 140 and the distal end portion 142.

The tapered seat valve 58 can control the selected fluid's 88 selected flowrate 116 by rotating the surrounding sidewall 136 or the distal end portion 142 as shown by adjustment 124 movement as best shown in FIGS. 14 and 15. Thus, adjustment movement 124 changes the effective flow area (see fluid communication 96 in FIG. 5) via the threads also shown in cross section in FIG. 5, thus resulting in the taper gap where fluid communication 96 is shown in FIG. 5 becoming larger for higher flowrates 116 or smaller for lower flowrates 116. Alternatively, the means 56 for controlling the selected fluid's flowrate 116 from the aperture 144 could be another type of valve that can manually control the selected fluid's 88 flowrate 116, such as a gate valve, cage valve, rotary valve, or the like that can be integral with the housing 132 or removably attachable to the housing.

Yet further, the fluid cleaning apparatus 130 includes an agitation element 60 that is disposed adjacent to the distal end portion 142 such that the aperture 144 is in fluid communication 98 with the agitation element 60 and an external environment 102, also as is best shown in FIG. 5. Wherein, operationally the agitation element 60 helps to dislodge 106 a particulate 104 from a selected surface 108 in conjunction with the selected fluid 88 to clean the selected surface 108 as best shown in FIGS. 14 and 15. Thus, in continuing to focus primarily upon FIGS. 14 and 15, the fluid cleaning apparatus 130 cleans the selected surface 108 two ways that are either effective together or effective separately, by firstly physically dislodging 106 the particle 104 from the agitation element 60 by manual movement 126 of the human hand 112 at the agitation element 60 as against the selected surface 108.

Then secondly by use of the selected fluid 88, that can also have two ways of helping to dislodge 106 the particle 108, a primary way by also physically dislodging 106 the particle 108 either by the selected fluid 88 flowing 116 outward away from the agitation element 60 into the external environment 102, thus “blowing” the particle 104 away from the selected surface 108 or by vacuum action, thus reversing the flow 116 to go from the external environment 102 into the agitation element and into the aperture 44, thus permanently removing the particle 104 from the selected surface 108. In addition, the selected fluid 88 can have solvent type properties that can reduce the adhesion of the particle 104 to the selected surface 108, by helping to reduce surface tension of the particle 104 to the selected surface 108. Thus, the fluid cleaning apparatus 130 can be more effective at cleaning by using the agitation element 60 and the selected fluid 88 to either physically remove the particle 104 and/or help to loosen the particle's 104 adhesion to the selected surface 108 for convoluted type surfaces 108 that are difficult to clean in a conventional manner.

The fluid cleaning apparatus 130 optionally has the housing 32 being sized and configured to be manually grasped 114 by a human hand 112 as shown in FIGS. 14 and 15. Focusing more particularly on the surrounding sidewall 136 of the housing 132 and looking at specifically FIGS. 4, 5, 14, and 15 the sizing and configuring of the surrounding sidewall portion 136 of the housing 132 to be manually grasped 114 by a human hand 112 requires that the side wall 136 diameter or other dimension that is positioned transverse to the longitudinal axis 134 be in the range of about 0.25 (one quarter inch) to 2.00 (two) inches. Note that the side wall 136 need not necessarily be round or circular at all, as it could be square, rectangular, elliptical, or any other shape that is transverse to the longitudinal axis 134. Also, there can optionally be ergometric type depressions in the sidewall 136 for fingers of the human hand 112 to reside in. In addition, the sidewall 136 surface that comes into contact with the human hand 112 can have a knurled type surface, or any other type of surface that increases the coefficient of friction between the human hand 112 and the sidewall 136 surface for more effective grasping 114 by the human hand 112.

On the fluid cleaning apparatus 130, the agitation element 60 can take on a number of alternative forms, referring specifically to FIG. 7; the agitation element 60 is alternatively a pick 48 including a cannula 50 with a lumen 52, wherein the aperture 144 is in fluid communication 100 with the lumen 52. Further, optionally the lumen 52 is sized with a flow restriction to control a flowrate 116 of the selected fluid 88. The lumen 52 flow restriction can be sized per standard orifice engineering calculations that set the cross sectional area, being transverse to the longitudinal axis 134 based upon the desired selected fluid 88 flowrate 116 coinciding with a desired pressure drop across the lumen 52 using the fluid properties of the selected fluid 88 such as density, viscosity, and the like. Further, in referring specifically to FIG. 8, the agitation element 60 can alternatively be an open celled foam element 62 that can have a variety of tip options opposite of the aperture 144 for cleaning the selected surface 108, as is shown in FIG. 8 the open celled foam element has a blunt nosed tip that could also be any other shape such as frustroconical, cylindrical, square, have a hollow tip, and the like. The selected fluid 88 will permeate through the open celled foam element 62 to enhance the cleaning process by allowing the selected fluid 88 to contact the selected surface 108, wherein the selected fluid 88 can ooze out of the open celled foam element 62 to slowly expose the selected fluid 88 to the selected surface 108.

In addition, focusing specifically on FIGS. 6 through 10, optionally the aperture 144 can be sized with a flow restriction to control a flowrate 116 of the selected fluid 88, as with the previously described lumen 52, the aperture 144 flow restriction can be sized per standard orifice engineering calculations that set the cross sectional area, being transverse to the longitudinal axis 134 based upon the desired selected fluid 88 selected flowrate 116 coinciding with a desired pressure drop across the aperture 144 using the fluid properties of the selected fluid 88 such as density, viscosity, and the like. As a further option, in looking at FIG. 9, the aperture 144 can be sized with a diffusing flow restriction 78, similar to a showerhead to control a flowrate and dispersion of the selected fluid 88. The diffusing flow restriction 78 can be sized and configured as a restriction orifice similar to the lumen 52 and aperture 144 previously described by utilizing a plurality of orifices flowing in a parallel manner per generally known engineering multiple orifice sizing calculations and based upon the desired selected fluid 88 selected flowrate 116 coinciding with a desired pressure drop across the diffusing flow restriction 78 using the fluid properties of the selected fluid 88 such as density, viscosity, and the like. Operationally, the diffusing flow restriction 78 acts to have the selected fluid 88 permeate out through the plurality of brush 64 bristles 66 more thoroughly to help the cleaning process of the selected surface 108.

Continuing on the alternatives for the agitation element 60, in looking at FIGS. 4 through 6, FIGS. 9, 10, and FIGS. 14 and 15, preferably the agitation element 60 is a brush 64 having a plurality of bristles 66. The bristles 66 are retained by an agitation element retainer 61, wherein the retainer 61 is attached to the distal end portion 142 through a shoulder arrangement that can be a slip fit, press fit, shrink fit, or alternatively attached by threads, a snap type fit, adhesive, or any other suitable method. On the bristles 66 themselves being attached to the retainer 61 by an adhesive, crimping, banding, or other method either or both at the bristle 66 proximal ends and/or outer radial portions. Note that a void can exist within the bristles 66 adjacent to the aperture 144 area. To better increase the effectiveness of the bristles in looking at the free tip portions or the distal ends of the plurality of brush bristles 68 that form the brush opening 70, modification of the brush opening profile 70 can be done to approximately match the selected surface 108 profile 110, wherein the free tip portions of the bristles 68 can more effectively physically dislodge 106 the particle 104 from the selected surface 108 that is typically convoluted or corrugated in profile. With the convoluted or corrugated selected surface 108 being difficult to clean conventionally.

One particular profile in referring to FIG. 3, is for the plurality of bristles free tip portions 68 to form a brush opening profile 70 that has a continuously curved perimeter 72 profile that defines a brush opening profile 70 that includes oppositely disposed concave sections 74 and oppositely disposed convex sections 76. Wherein the concave 74 and convex 76 sections are continuous forming the continuously curved perimeter profile 72, with the concave 74 or convex 76 surfaces being approximately matched in brush opening 70 profile 72 to the selected surface 108 profile 110 to be cleaned. Note that although FIG. 3 is for the fluid cleaning apparatus 30, the agitation element portion 60 and the above description for the concave 74 and convex 76 sections is the same for the alternative embodiment of the fluid cleaning apparatus 130.

Taking this even a step further, in referring specifically to FIG. 10, by making the brush 64 bristles 69 manually selectively adjustable in creating a custom brush 64 opening 70 profile, almost any selected surface 108 profile 110 can be accommodated for effective cleaning. Thus, each of the brush 64 plurality of bristles 66 are sized and configured to be each selectively positioned 122 substantially along the longitudinal axis 134 to operationally further accommodate an approximate match in profile formed at a selected brush 64 opening profile 70 to a profile 110 of the surface 108 to be cleaned. See FIG. 15 as specifically the selected brush 64 opening profile 82 that substantially matches the selected surface 108 profile 110 for making the particle 104 dislodging 106 more effective. This sizing and configuring, as shown in FIG. 10, is preferably accomplished by the addition of an agitation element inner retainer 63 that radially “sandwiches” the plurality of bristles 66 between the agitation element outer retainer 61. Thus, resulting in a frictional slidable engagement of the plurality of bristles 66 in between the outer retainer 61 and the inner retainer 63 substantially along the longitudinal axis 134, wherein the inner retainer 63 may or may not be attached to the distal end portion 42.

### Method of Use

Referring primarily to FIGS. 13 to 15 and specifically to FIGS. 14 and 15, a method of use is disclosed for the fluid cleaning apparatus 130 for manually cleaning a selected surface 108 with a selected fluid 88, comprises the steps of, first, firstly providing a fluid cleaning apparatus 130, as best structurally disclosed in FIGS. 4 and 5, that includes a housing 132 that has a surrounding sidewall 136 positioned about a housing 132 longitudinal axis 134. The sidewall 136 defining a housing 132 interior 138 in between a proximal end portion 140 and a distal end portion 142, the proximal end portion 140 is adapted to removable engage 190 a fluid interface 184 having means so for creating a selected fluid's 88 flowrate 116 as previously described. With fluid communication 94 existing between the housing 132 interior 138 and the means 86 for creating the fluid flowrate 116, the distal end portion 142 including an aperture 144 that is in fluid communication 96 with the housing 132 interior 138. Also included in the provided fluid cleaning apparatus 130 is a means 56 for controlling the selected fluid's 88 flowrate 116 from the aperture 144, and an agitation element 60 that is disposed adjacent to the distal end portion 142 such that the aperture 144 is in fluid communication 98 with the agitation element 60 and the external environment 102. Looking in particular at FIG. 10, for structurally wherein the agitation element 60 is preferably a brush 64 that includes a plurality of bristles 66, each of the brush 64 plurality of bristles 66 are sized and configured to be each selectively positioned 80 substantially along the longitudinal axis 134 to operationally further accommodate an approximate match in profile formed at a selected brush opening profile 82 to a profile 110 of the surface 108 to be cleaned.

A second step is in attaching 120 the proximal end portion 140 to the fluid interface 184, as detailed out structurally in FIG. 5 and shown attached 120 or assembled in FIGS. 14 and 15. Typically this attaching 120 is a removable engagement 190 of the fluid interface 184 that is substantially fluid 88 tight. Further continuing, in referring to FIG. 10 structurally and FIG. 15 use wise, a third step is in positioning 122 manually the plurality of brush bristles 66 to form a selected brush 64 opening profile 82 to further accommodate an approximate match in the brush 64 opening profile 82 to a selected surface 108 profile 110. Next, in referring specifically to FIG. 15, a forth step is in adjusting 124 the means 56 for controlling the selected fluid's 88 flowrate 116 to further help in dislodging 106 particles 104 from the selected surface 108 profile 110. Yet further continuing, again referring to FIG. 15, a fifth step is in manually moving 126 the selected surface 108 profile 110, wherein the brush 64 opening profile 82 and the selected surface 108 profile 110 are in substantially matching profile contact. Operationally, the particles 104 are assisted in being dislodged 106 from the selected surface 108 profile 110 from the dislodging action of the brush 64 bristles 66 on the selected surface 108 profile 110 in conjunction with the selected fluid 88 flowrate 116 that also helps to dislodge 106 particles 104 from the selected surface 108 profile 110.

### Conclusion

Accordingly, the present invention of a fluid cleaning apparatus 30 has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A fluid cleaning apparatus adapted for use with a fluid interface that is in fluid communication with a means for creating a fluid flowrate of a selected fluid, said apparatus comprising:
(a) a housing that includes a surrounding sidewall positioned about a housing longitudinal axis, said sidewall defining a housing interior in between a proximal end portion and a distal end portion, said proximal end portion adapted to removably engage the fluid interface with fluid communication between said housing interior and the means for creating the selected fluid's flowrate, said distal end portion including an aperture that is in fluid communication with said housing interior; and
(b) an agitation element that is disposed adjacent to said distal end portion such that said aperture is in fluid communication with said agitation element and an external environment, wherein operationally said agitation element helps to dislodge a particulate from a selected surface in conjunction with the selected fluid to clean the selected surface.

2. A fluid cleaning apparatus according to claim 1 wherein said housing is sized and configured to be manually grasped by a human hand.

3. A fluid cleaning apparatus according to claim 1 wherein said agitation element is a pick including a cannula with a lumen, wherein said aperture is in fluid communication with said lumen.

4. A fluid dispenser according to claim 3 wherein said lumen is sized with a flow restriction to control a flowrate of the selected fluid.

5. A fluid cleaning apparatus according to claim 1 wherein said agitation element is an open celled foam element.

6. A fluid cleaning apparatus according to claim 5 wherein said aperture is sized with a flow restriction to control a flowrate of the selected fluid.

7. A fluid cleaning apparatus according to claim 1 wherein said agitation element is a brush having a plurality of bristles.

8. a fluid dispenser according to claim 7 wherein said aperture is sized with a diffusing flow restriction to control a flowrate and dispersion of the selected fluid.

9. A fluid cleaning apparatus according to claim 7 wherein said brush plurality of bristles have free tip portions that form a brush opening that has a continuously curved perimeter profile that defines said brush opening that includes oppositely disposed concave sections and oppositely disposed convex sections, wherein said concave and convex sections are continuous, said concave or convex surfaces are a approximately matched in profile to the selected surface to be cleaned.

10. A fluid cleaning apparatus according to claim 7 wherein each of said brush plurality of bristles are sized and configured to be each selectively positioned substantially along said longitudinal axis to operationally further accommodate an approximate match in profile formed at a selected brush opening profile to a profile of the surface to be cleaned.

11. A fluid cleaning apparatus adapted for use with a fluid interface that is in fluid communication with a means for creating a fluid flowrate of a selected fluid, said apparatus comprising:
(a) a housing that includes a surrounding sidewall positioned about a housing longitudinal axis is, said sidewall defining a housing interior in between a proximal end portion and a distal end portion, said proximal end portion adapted to removably engage the fluid interface with fluid communication between said housing interior and the means for creating the selected fluid's flowrate, said distal end portion including an aperture that is in fluid communication with said housing interior;
(b) a means for controlling the selected fluid's flowrate from said aperture; and
(c) an agitation element that is disposed adjacent to said distal end portion such that said aperture is in fluid communication with said agitation element and an external environment, wherein operationally said agitation element helps to dislodge a particulate from a selected surface in conjunction with the selected fluid to clean the selected surface.

12. A fluid cleaning apparatus according to claim 11 wherein said housing is sized and configured to be manually grasped by a human hand.

13. A fluid cleaning apparatus according to claim 11 wherein said agitation element is a pick including a cannula with a lumen, wherein said aperture is in fluid communication with said lumen.

14. A fluid cleaning apparatus according to claim 11 wherein said agitation element is an open celled foam element.

15. A fluid cleaning apparatus according to claim 11 wherein said agitation element is a brush having a plurality of bristles.

16. A fluid cleaning apparatus according to claim 15 wherein said aperture is configured with a flow diffuser to further enhance dispersion of the selected fluid.

17. a fluid cleaning apparatus according to claim 15 wherein said brush plurality of bristles have free tip portions that form a brush opening that has a continuously curved perimeter profile that defines said brush opening that includes oppositely disposed concave sections and oppositely disposed convex sections, wherein said concave and convex sections are continuous, said concave or convex surfaces are approximately matched in profile to the selected surface to be cleaned.

18. A fluid cleaning apparatus according to claim 15 wherein each of said brush plurality of bristles are sized and configured to be each selectively positioned substantially along said longitudinal axis to operationally further accommodate an approximate match in profile formed at a selected brush opening profile to a profile of the surface to be cleaned.

19. a fluid cleaning apparatus according to claim 11 wherein said means for controlling the selected fluid's flowrate is accomplished by a tapered seat type valve.

20. A method of using a fluid cleaning apparatus for manually cleaning a selected surface with a selected fluid, comprising the steps of:
(a) providing a fluid cleaning apparatus that includes a housing with a surrounding sidewall positioned about a housing longitudinal axis, said sidewall defining a housing interior in between a proximal end portion and a distal end portion, said proximal end portion adapted to removably engage a fluid interface having a means for creating a selected fluid's flowrate, with fluid communication between said housing interior and the means for creating the fluid flowrate, said distal end portion including an aperture that is in fluid communication with said housing interior, a means for controlling the selected fluid's flowrate from said aperture, and an agitation element that is disposed adjacent to said distal end portion such that said aperture is in fluid communication with said agitation element and an external environment, wherein said agitation element is a brush that includes a plurality of bristles, each of said brush plurality of bristles are sized and configured to be each selectively positioned substantially along said longitudinal axis to operationally further accommodate an approximate match in profile formed at a selected brush opening profile to a profile of the surface to be cleaned;
(b) attaching said proximal end portion to the fluid interface;
(C) positioning manually said plurality of brush bristles to form a selected brush opening profile to further accommodate an approximate match in said brush opening profile to a selected surface profile;
(d) adjusting said means for controlling the selected fluid's flowrate to further help in dislodging particles from the selected surface profile; and
(e) moving said selected brush opening profile back and forth across the selected surface profile, wherein said brush opening profile and the selected surface profile are in substantially matching profile contact, operationally the particles are assisted in being dislodged from the selected surface profile from the dislodging action of brush bristles on the selected surface profile in conjunction with the selected fluid flowrate that also helps to dislodge particles from the selected surface profile.
